(19) United States
(12) Patent Application Publication
(10) Pub. No.: US 2008/0153432 A1
(43) Pub. Date: Jun. 26, 2008

(54) METHOD AND SYSTEM FOR CONVERSATION BREAK-IN BASED ON USER CONTEXT

(75) Inventors: XIAO-FENG ZHU, Nanjing (CN); ZHUO-MING DAI, Nanjing (CN); VON A. MOCK, Boynton Beach, FL (US)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/613,824

(22) Filed: Dec. 20, 2006

(51) Int. Cl. H04B 1/38

(52) U.S. Cl. 455/90.2

(57) ABSTRACT

A method for push-to-talk (PPT) break-in in a push-over-cellular (PoC) system is provided. The method can include assessing (202) user context levels for users of mobile devices, prioritizing (204) a break-in precedence for the users based on the user context level, and granting (206) a break-in request (420) to users engaged in conversation in order of priority. The user context levels can identify a hierarchical relationship of the users to set a precedence for break-in. The user context levels can be based on a user role (371), a calendar (388), an organizational chart (307), a family relationship (379), or a social network (308).

### FIELD OF THE INVENTION

The present invention relates to mobile communication devices, and more particularly, to managing users in a push-to-talk group communication network.

### BACKGROUND OF THE INVENTION

The use of portable electronic devices and mobile communication devices has increased dramatically in recent years. Two primary means of voice communication are generally offered in mobile devices: Interconnect and dispatch. Interconnect is a communication mode by which both parties can speak at the same time. It is considered a two-way communication since both parties can talk and listen on a separate talk channel and a separate receive channel. Interconnect communication is also available for three-way calling or group call. In contrast, dispatch mode is a communication mode where only one party can speak at a time. The other party can only listen until the first party finishes talking. In practice, a push-to-talk (PTT) key is pressed to acquire control of a talk channel. The talk channel is not released until the PTT key is released. Upon release, another participant can acquire the talk channel. Dispatch mode is also available for three-way dispatch or group dispatch.

During dispatch mode a participant outside of the group call, or the dispatch call, cannot generally acquire the talk channel for a pre-determined amount of time. In dispatch mode, the talker and the listener establish a hard physical link until an inactivity timer expires. Although the activity timer allows for a fast set up time between current users of the group call, it also sets a limit to when the talk channel can be acquired. Accordingly, a participant must either wait for the activity timer to expire, or try to call again at a later time. In a cellular network, once a base station establishes a call session between users or users of the same group (Group call), a busy signal is given to any user who is trying to reach one of the active session members. A base station will return a ‘user busy’ signal to any one if the target is already involved in an active session.

### SUMMARY

One embodiment is a method for push-to-talk (PPT) break-in. The method can include assessing user context levels for users of mobile devices, prioritizing a break-in precedence for users based on the user context level, and granting a break-in request to users engaged in conversation in order of priority. The step of assessing a user context can further include identifying a hierarchical relationship of the users, and the prioritizing can be based on a user role, user calendar, or time of day. In one configuration, the prioritizing can be based on an employee directory listing, a family relationship, safety management, or emergency situations. In another configuration the prioritizing can be based on social networking, wherein a first user is socially more closer than a second user is given a higher priority than the second user. The prioritizing can also be based on a temporary period of time.

The method can further include receiving a request from a first mobile device to break-in an active call of a target mobile device, determining a first priority of the first mobile device during the active call in view of the user context levels, and granting the break-in if the first priority is greater than or equal to a current priority of a mobile device engaged in the active call. In one arrangement the user context levels can be stored in a priority list on a mobile device or a network server. The step of determining a first priority can further include receiving priorities from mobile devices engaged in the active call, and comparing the first priority to the priorities received. An indication can be provided to users when the break-in is granted. The step of granting the break-in can include sending a first message to suspend the active call, sending a second message to accept the call from the first mobile device, and connecting the first mobile device and the target mobile device in a second active call. It can be appreciated that the message for communicating between the first and second device can be realized by sending the message between the two devices in a first and second audio mute frame. In addition, other forms of message delivered can be realized through a SIP (Session Initiated Protocol) or other IP based delivery protocols as well as proprietary solutions.

Another embodiment is directed to a system for push-to-talk (PTT). The system can include a fixed network equipment (FNE) that receives a request from a first mobile device to break-in an active call of a target mobile device and arbitrates the active call of the target mobile device and the break-in of the first mobile device in accordance with priorities identified by user context levels. In one arrangement, the target mobile device can receive the request from the first mobile device, compare a first priority of the first mobile device to a list of priorities that identify a break-in priority for mobile devices in the active call, and grant the break-in to the active call if the first priority is greater than a second priority of a second mobile device in the active call, wherein the user context identifies a hierarchical relationship between the users. The system can identify which mobile device is in control of a talk channel during the active call, and evaluate a break-in priority based on the mobile device that has control of the talk channel. In one aspect, the system can grant the break-in during a talk time of the target mobile device if the first priority is greater than a priority of the target mobile device. In another aspect, the system can grant the break-in during a talk time of the second mobile device if the first priority is greater than the second priority.

Yet another embodiment is directed to a push-over-cellular (PoC) system providing push-to-talk (PTT) break-in. The system can include a target mobile device engaged in an active call, a first mobile device that sends a request to break-in the active call of the target mobile device, and a fixed network equipment (FNE) that receives the request and arbitrates the active call of the target mobile device and the break-in of the first mobile device based on a user context that identifies a hierarchical relationship among users. The target mobile device can receive the request from the first mobile device, compare a first priority of the first mobile device to a list of priorities that identify a break-in priority for mobile devices in the active call based on user context levels, and grant the break-in to the active call if the first priority is greater than a second priority of a second mobile device in the active call. In one aspect, the user context can establish a precedence of break-in based on a user role, user calendar, or time of day. The user context can also identify a precedence of break-in based on an employee directory listing, a family relationship, safety management, or emergency situations. The user context can also identify a precedence of break-in based on social networking, wherein a first user is socially closer than a second user is given a higher priority than the second user.

One embodiment is a method for establishing break-in precedence. The method can include assessing a user context level within a conversation, prioritizing users in the conversation based on the user context level, and granting conversation control to users in order of priority. The step of assessing a user context can include identifying a hierarchical relationship of the users in the conversation. In one aspect, the prioritizing can be based on a user role, user calendar, or time of day. The prioritizing can also be based on an employee directory listing, a family relationship, safety management, or emergency situations. In yet another aspect, the prioritizing can be based on social networking, wherein a first user is socially closer than a second user is given a higher priority than the second user.

### BRIEF DESCRIPTION OF THE DRAWINGS

The features of the system, which are believed to be novel, are set forth with particularity in the appended claims. The embodiments herein, can be understood by reference to the following description, taken in conjunction with the accompanying drawings, in the several figures of which like reference numerals identify like elements, and in which:

FIG. 1 is a wireless communication system for providing push-to-talk (PTT) break-in based on selection priority in accordance with the embodiments of the invention;

FIG. 2 is a method for establishing break-in precedence based on user context in accordance with the embodiments of the invention;

FIG. 3 is a list steps for prioritizing a user context in accordance with the embodiments of the invention;

FIG. 4 is an organizational chart that establishes break-in precedence in accordance with the embodiments of the invention;

FIG. 5 is an social network that establishes break-in precedence in accordance with the embodiments of the invention;

FIG. 6 is a list of priority records in accordance with the embodiments of the invention;

FIG. 7 is a depiction of a group of mobile devices in an active call receiving a break-in request from another mobile device in accordance with the embodiments of the invention;

FIG. 8 is a depiction of a group of mobile devices in a suspended call and a group of mobile devices in a new active call in accordance with the embodiments of the invention;

FIG. 9 is a depiction of a group of mobile devices in a restored active call in accordance with the embodiments of the invention;

FIG. 10 is a depiction of a first mobile device receiving authorization to break-in a call in accordance with the embodiments of the invention;

FIG. 11 is a depiction of a first mobile device unable to receive authorization to break-in a call in accordance with the embodiments of the invention; and

FIG. 12 is a flow diagram for call break-in based on a master device and slave device relationship in accordance with the embodiments of the invention.

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

The term “talk channel” can be defined as a transmit communication channel that is shared amongst a plurality of mobile devices. The term “talk time” can be defined as the time between when a talk channel is acquired and when the talk channel is released. The term “hang-time” can be defined as the time between when a talk channel is released until the talk channel is again acquired. The term “PTT request” can be defined as an attempt to push to talk, either by hardware or software. The term “PTT key” can be defined as a physical button or a soft-key. The term “soft-key” can be defined as a software controlled button. The term “PTT group call” can be defined as a group call based on push-to-talk requests. The term “break-in” can be defined as disrupting an active call and acquiring the talk channel in the active call, or pre-empting a conversation. The term “priority” can be defined as a control precedence of one mobile device over another mobile device. The term “current priority” can be defined as the priority of the mobile device that has current control of the talk channel. The term “arbitrate” can be defined as negotiating control of a talk channel. The term “target mobile device” can be defined as a mobile device receiving a break-in request from another mobile device. The term “suspend” can be defined as temporarily pausing, or terminating, a call connection of an active call. The term “active call” can be defined as a call connection that is currently in progress, or occurring within an activity timer. The term “user context” can be defined as a current situation of a conversation.

Broadly stated, embodiments of the invention are directed to a method and system that allows a new user to break-in to an active call based on user context levels. The user context levels identify priorities that can be based on a hierarchical relationship among users. The hierarchical relationship identifies which users can break-in to an active call based on precedence. This allows users with a higher user context to effectively interrupt a call. For example, an organizational chart may offer a manager higher precedence to break-in an active call than an employee. As another example, a parent may have a higher precedence to break-in an active call than a child. Moreover the precedence can be dynamically adjusted based on a user's context role within a conversation. For example, during the course of a presentation one or more speakers can be assigned as presenters. Other members can be assigned as listeners. The precedence can change when the presentation is over, or when a question and answer session commences. As another example, a customer may be given higher precedence in a sales call than other employees on the call. As yet another example, an emergency dispatcher may be given a higher precedence over a police officer when responding to a critical situation.

In another aspect, a precedence for break-in can be temporally based. In yet another aspect, the precedence can automatically adjust based on a user's role throughout the day. For example, a user profile can include a calendar that identifies priorities throughout the day. As another example, a temporary authorization for priority can be granted to certain users for certain time periods throughout the day. In yet another arrangement, the priorities can be based on social networking for establishing break-in precedence. For example, a priority level can be determined based on a number of nodes that are connected to a user, which indicates how well the user is connected.

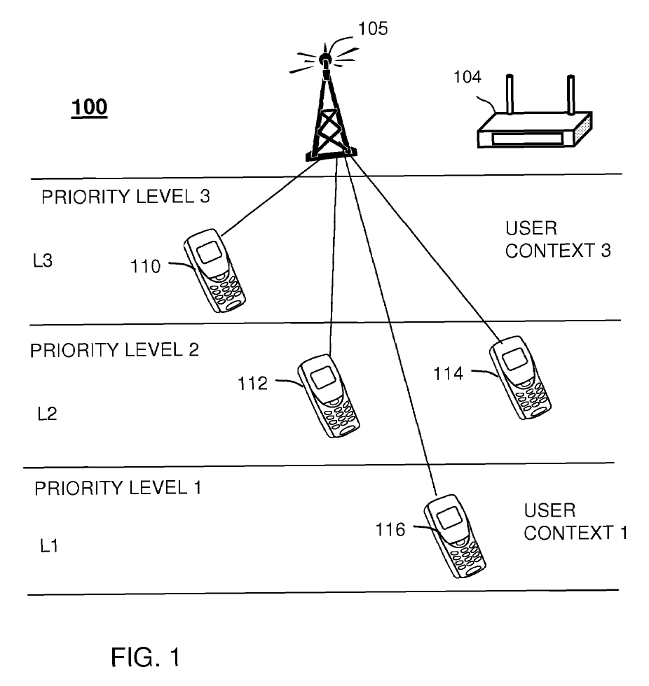

Referring to FIG. 1, a wireless communication system 100 for providing push-to-talk (PTT) break-in based on selection priority is shown. The wireless communication system 100 provides call handling control to allow call break-in to a conversation. Briefly, the mobile devices can be ordered by a priority of break-in based on user context. The priority identifies a precedence by which mobile devices can break-in to an active call of another mobile device. An active call may be a dispatch group call between two or more mobile devices. For example, mobile device 110 can have a priority level 3 which can be the highest priority for break-in. The highest priority can be associated with user context level 3. For example, user context level 3 may correspond to the user leading the active call. Mobile device 112 and mobile device 114 can have a priority level 2 which is the second highest priority level. The second priority can be associated with user context level 2. Mobile device 116 can have priority level 1 which is the lowest priority level. The lowest priority can be associated with user context level 1. Notably, the number of priority levels can be more than or less than the number of priority levels shown. For instance, if mobile device 112 is in an active call with mobile device 114, then mobile device 110 can break-in to the active call. This is because, mobile device 110 has a higher priority than either mobile device 112 of mobile device 114 based on user context levels.

In one arrangement, the wireless system 100 can provide wireless connectivity or dispatch connectivity over a radio frequency (RF) communication network. The wireless communication system 100 can also provide push-to-talk (PTT) over cellular (PoC) and Voice over IP (VoIP). The wireless communication system 100 can include a plurality of mobile devices 110-116 communicating amongst one another in a group call or with other mobile devices or servers in the wireless communication system 100. As one example, the mobile devices 110-116 can communicate with one or more cellular towers 105 using a standard communication protocol such as CDMA, GSM, or iDEN, but is not herein limited to these. The one or more cellular towers 105, in turn, can connect the mobile devices through a cellular infrastructure to other mobile devices or resources on other networks.

Mobile devices 110-116 in the wireless communication system 100 can also connect amongst one another over a Wide Local Area Network (WLAN) 104 within an ad-hoc group. The WLAN 104 provides wireless access within a local geographical area. The mobile devices 110-116 can communicate with the WLAN 104 according to the appropriate wireless communication standard. In another arrangement, the mobile devices can communicate amongst themselves in a peer-to-peer ad-hoc network without infrastructure or WLAN support. For example, the mobile device can use short-range radio communication to engage in a group call in a peer-to-peer mode. In a typical WLAN implementation, the physical layer can use a variety of technologies such as 802.11b or 802.11g Wireless Local Area Network (WLAN) technologies. The physical layer may use infrared, frequency hopping spread spectrum in the 2.4 GHz Band, or direct sequence spread spectrum in the 2.4 GHz Band, or any other suitable communication technology.

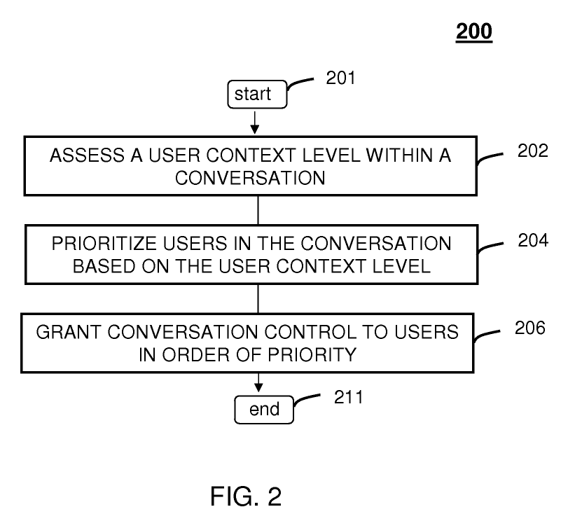

### FIG. 2

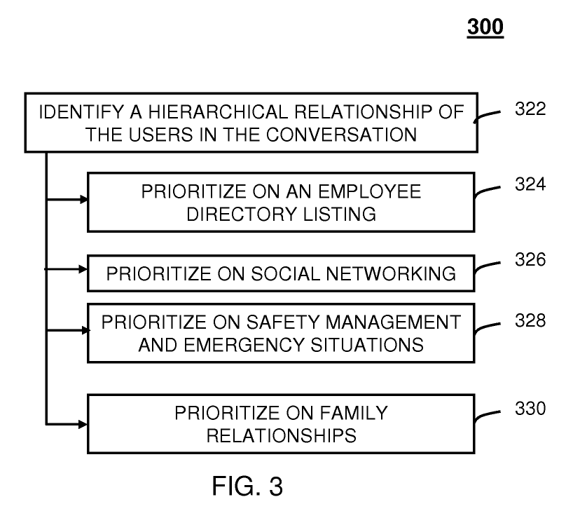

Referring to FIG. 2, a method 200 for providing push-to-talk (PTT) break-in based on user context levels is shown. A user context can identify a user role during a conversation that sets a break-in precedence. The method 200 can be practiced with more or less than the number of steps shown. To describe the method 200, reference will be made to FIG. 3-6, although it is understood that the method 200 can be implemented in any other manner using other suitable components.

At step 201, the method 200 can start. The method can start in a state wherein a conversation is occurring between two or more users. For example, referring back to FIG. 1, the conversation may be between all the mobile devices 110-116 or just two of the mobile devices, for example mobile device 110 and mobile device 112.

At step 202, a user context level can be assessed within the conversation. A user context can identify a user's role within the conversation. A user can be of many role types during the day that would change the priority level. For example, a user context may identify a user in the conversation as an employee or a manager. The manager can receive a higher precedence for break-in than the employee. As another example, a user context can establish precedence based on a family relationship. A parent can receive a higher precedence for break-in than a child. As another example, a user context can establish precedence based on a social networking. A user that has more social interaction with a particular individual can receive a higher precedence than another user who has less social interaction with the same individual. As another example of social networking precedence, a user that has more social connections can receive a higher precedence than a user with fewer social connections. As another example, a user context can establish precedence based on safety management and emergency situations. An emergency medical operator can receive a higher precedence than a police operator.

Referring back to FIG. 1, each of the mobile device 110-116 in the conversation can assess the user context of the other mobile devices. However, generally, the mobile device that initiated the conversation can be responsible for assessing user context and prioritizing users in the conversation. In the foregoing, mobile device 112 will be considered the master device; that is, the mobile device that initiated the conversation. Prior to initiating the conversation, the user of the mobile device 112 can assign a conversation type.

As an example, the user initiating the conversation may assign the conversation as a business conference, a sales conference, a family call, a personal call, or any other type of conversation type. Depending on the conversation type selected, the mobile device 112 can refer to a list of priorities associated with the conversation type. For example, if the conversation is a business call, the mobile device can retrieve an organizational chart to identify the user context roles and assign priorities in accordance with the organizational chart. If the conversation is a family call, the mobile device can retrieve a list of family members with priorities based on family relationships.

### FIG. 3/4

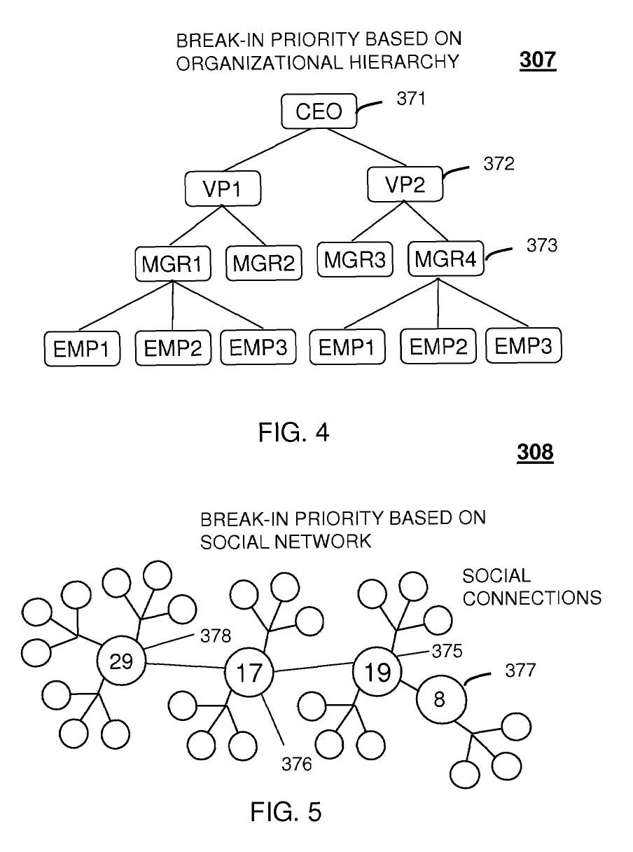

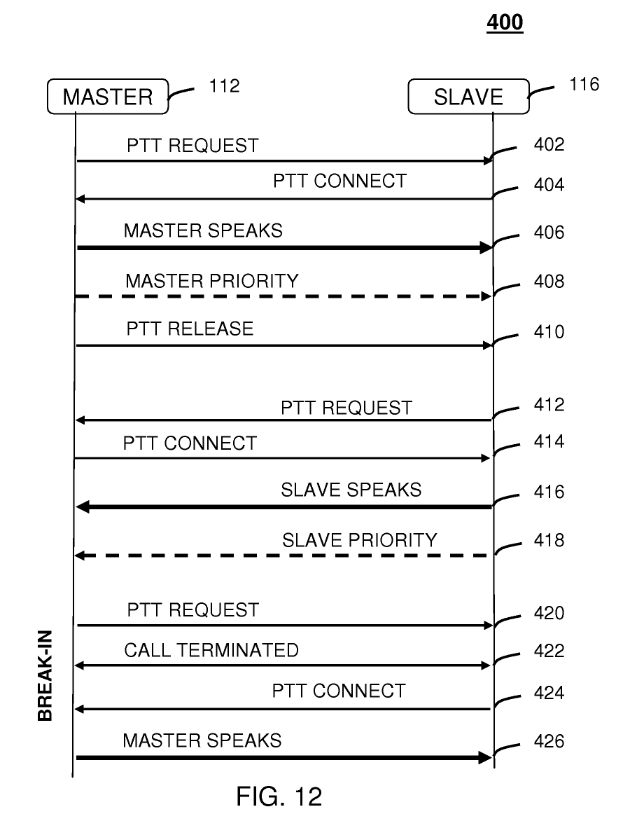

Returning back to FIG. 2, at step 204, users in the conversation can be prioritized based on the user context level. The user context level identifies the precedence for break-in on the conversation. Referring to FIG. 3, at step 322 of FIG. 12, the user context level can be assessed based on a hierarchical relationship of the users in the conversation. For example, at step 324, a precedence of break-in can be prioritized in accordance with an employee directory listing. Referring to FIG. 4, an employee directory listing can be an organizational chart 307 that is available to the master device. The master device can refer to the organization chart 307 to establish priority of users. For instance, the CEO 371 can have break-in priority of anyone below the CEO in the organizational chart. A VP 372 can have priority over a manager 373 but not over a VP. Accordingly, during a conversation, the precedence of break-in accords with the hierarchical relationship of the organizational chart.

### FIG. 5

As another example, referring to step 326 of FIG. 3, a precedence of break-in can be prioritized in accordance with social networking. Social networking identifies users having more social connections. For example, referring to FIG. 5, a social network 308 is shown. Users in the social network 308 can be prioritized based on the social closeness. For instance, a user 378 in a conversation with user 375 can be interrupted by users 376 or 377 if they would like to communicate with user 375. Additionally, social closeness can be further defined by the amount cumulative time communicating between individuals as well as the amount of time spent in close proximity to an individual.

As another example, referring to step 328 of FIG. 3, a precedence of break-in can be prioritized in accordance with safety management and emergency situations. For example, in response to a 911 call, the master device can prioritize all incoming call requests based on an emergency type. For example, a medical operator may have higher precedence that a police dispatch operator who has precedence over a business contact.

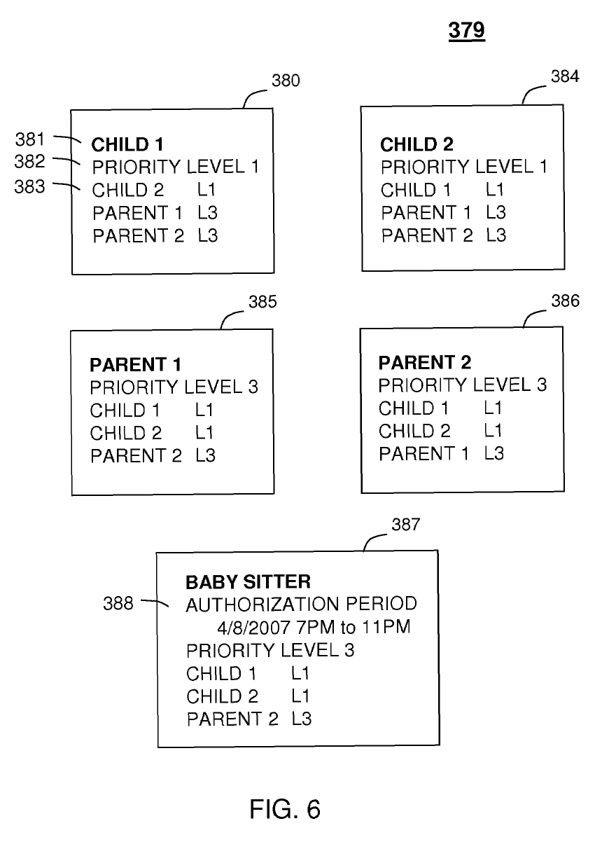

FIG. 6

As another example, referring to step 330 of FIG. 3, a precedence of break-in can be prioritized in accordance with family relationships. For example, referring to FIG. 6 a list of family records 379 is shown. The family records 379 can be retrieved when the user makes a call to a user in the family records. For instance, a user may have a list of contacts each associated with a user context. Upon calling a contact, the master device automatically retrieves the user context associated with the contact. As shown in FIG. 6, a family record (380) can identify a name of the user, Child 1 (381), a priority level (382), and a list of priorities (383) for other family members. The list of priorities 383 in the family record 380 identifies the precedence of break-in for the Child 1 (381). Similarly, a family record 384 for Child 2 identifies a priority level of Child 2 and a list of priorities for Child 2, a family record 385 for Parent 1 identifies a priority level of Parent 1 and a list of priorities for Parent 1, a family record 386 for Parent 2 identifies a priority level of Parent 2 and a list of priorities for Parent 2. It should be noted that the priorities can be programmed by the family members or programmed by a service provider. The priorities may be automatically set when a group of phones is purchased and thereafter updated if necessary. Additionally, it can be appreciated that the priority levels can be maintained in a network server or any other infrastructure element. Furthermore the priority levels can be stored in a SIM card SIM or removable card that can be moved by the users between the different phones

In another case, a temporary priority level can be assigned to a user. For example, in a family user context, a babysitter may need to set the priority levels of the children's mobile devices so that the babysitter can override the children's conversation while allowing the parent's an even higher priority level. Again, referring to FIG. 6, a temporary authorization 388 can be included in the family record 387 of the babysitter to identify a period for break-in priority. It should also be noted that the priorities can be set individually on each device, or relayed to a central mobile device that can set all the priorities. For example, the parents can send an email message containing the family record 387 for the babysitter. The baby sitter can accept the email and the settings can be automatically adjusted for the temporary authorization to the family group.

Returning back to FIG. 2, at step 206, conversation control can be granted to users in order of priority. Notably, the highest priority level between two or more mobile devices grants the user with resources reservation on the other device along with conversation control. The resource reservation allows the user to continue with a conversation without others that are not participating members within the group to break-in. The conversation control is given to the device with the highest priority level that allows the user to interrupt or halt an ongoing conversation. A master phone would be the phone within the current context that would have the highest priority.

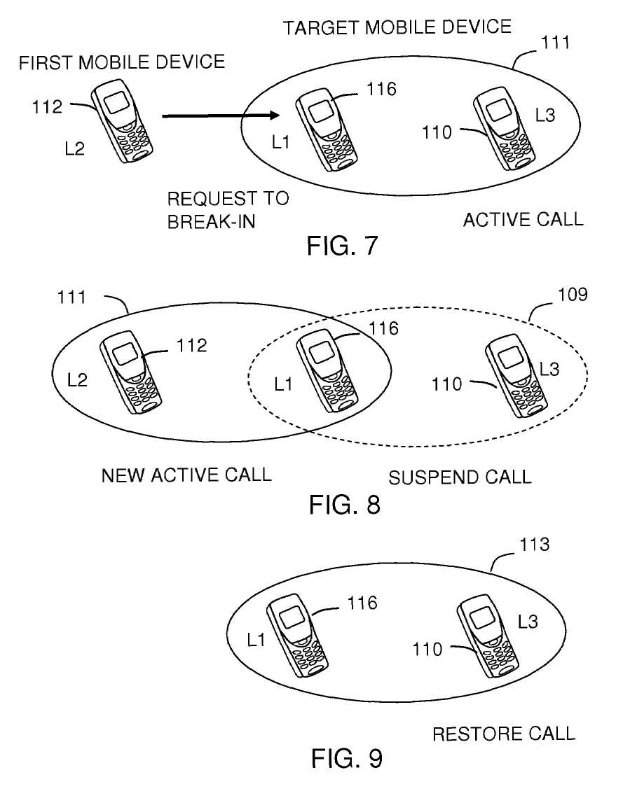

### FIG. 7

The break-in can be granted if the priority is greater than or equal to a current priority of a mobile device engaged in the active call. For example, referring to FIG. 7, the target mobile device 116 is in an active call with the second mobile device 110. The target mobile device 116 has an L1 priority and the second mobile device 110 has an L3 priority. The first mobile device 112 requesting the break-in has a priority of L2. In one arrangement, the priority of break-in depends on the mobile device that has the highest priority in the active call 107. In such regard, the mobile device with the highest priority in the active call 107 sets the break-in priority. For example, referring to FIG. 7, the second mobile device 110 with a priority of L3 sets the priority. Accordingly, only a mobile device of priority L3 or higher can break-in the active call 107. Consequently, the first mobile device 112 cannot break in the active call 107, until the second mobile device 110 terminates the active call 107 with mobile device 110. Accordingly, the first mobile device 110 must wait for the active call 107 to end, based on the order of priority.

FIG. 8

Upon determining the priority of the first mobile device 112, the target mobile device 11 6 can authorize the break-in if the priority of the first mobile device 112 is greater than or equal to the priority of the target mobile device 116 and the second mobile device 110. In order to break-in, the active call 107 is first suspended 109 to disengage the target mobile device 116 with the second mobile device 110. As an example, referring to FIG. 8, the target mobile device 116 can suspend the active call 107 by sending a message to a fixed network equipment (FNE) supporting the call thereby producing a suspended call 109. After the break-in has been granted, a new active call 111 can be set up between first mobile device 112 and target mobile device 116 as shown in FIG. 8.

FIG. 9

An indication can be provided to all parties on the active call, the target mobile device 116, and the first mobile device 112 when the break-in is granted. For example, an automated indication can be presented to the target mobile device 116 to inform the mobile device 11 6 that a new call is being set up with the first mobile device 112. An automated indication can also be presented to the second mobile device 110 to inform the second mobile device 110 that the active call is being temporarily suspended. After the new active call has terminated, the original active call can be restored 113 as shown in FIG. 9. Returning back to FIG. 2, at method step 211, the method 200 can end.

In another arrangement, the priority of break-in can depend on which mobile device has control of the talk channel. Briefly, a mobile device has control of the talk channel when a user has acquired a transmit channel through a PTT request. For example, a user that has pressed the PTT button, and has acquired resources to transmit on the talk channel, has control of the talk channel. The user can talk while control of the talk channel is acquired, which corresponds to the talk time. During talk-time the mobile device that initiated the communication has control of the talk channel.

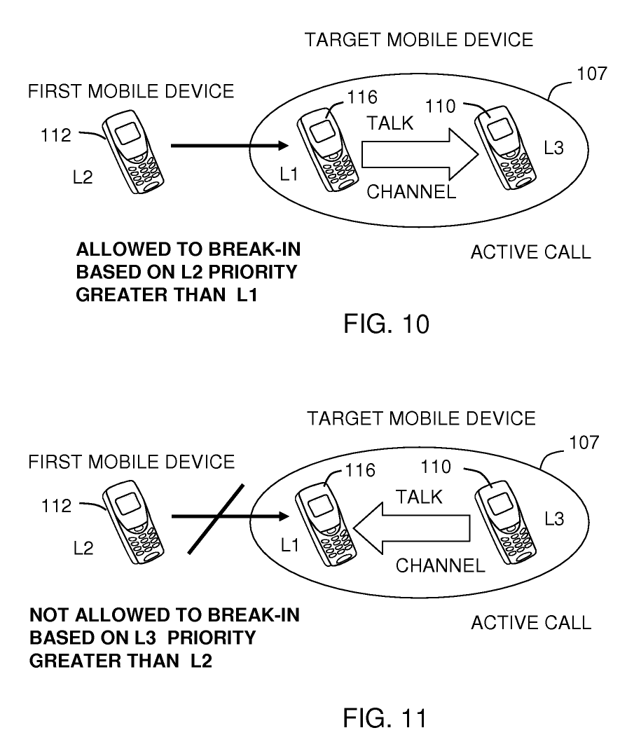

FIG. 10/11

FIGS. 10 and 11 provide a depiction for authorizing break-in priority based on a current control of the talk channel. In particular, during dispatch communication, only one radio at a time can acquire the talk channel. The method 200 of break-in using selection priority based on user context prevents a low priority device from overriding a high priority device. However, it allows a mobile device to break-in to a conversation of a higher priority device, though it does not allow the mobile device to interrupt the higher priority device. In this case, a user can break in to a conversation with a higher priority mobile device, though, the lower priority device cannot directly interrupt the higher priority mobile device.

For example, as shown in FIG. 10, the first mobile device 112 can only break into the active call when the lower priority mobile device 116 has control of the talk channel. That is, the first mobile device 112 can break-in the active call to the target device 116 during a talk-time of the target mobile device 116, since the first priority of the first mobile device 112 is greater than the priority of the target mobile device 116.

Referring to FIG. 11, the first mobile device 112 cannot break into the active call when the higher priority mobile device 110 has control of the talk channel. That is, the first mobile device 112 cannot break-in to the active call 107 during a talk-time of the second mobile device 110, since the priority of the second mobile device 110 is greater than the priority of the first mobile device 112.

Referring to FIG. 12, a flow diagram 400 for push-to-talk (PTT) break-in based on selection priority for a master and slave is shown. Briefly, the flow diagram 400 identifies the exchange of messages between a master mobile device and a slave mobile device during a conversation. The flow diagram 400 can include more or less than the number of steps shown. Moreover, the flow diagram 400 only generally described the communication between the master and the slave. An intermediary device, such as an FNE in the cellular infrastructure, can also handle call control for the conversation. In the exemplary flow diagram 400, the master device 112 which has an L2 priority has break-in priority over the slave mobile device 116 which has L1 priority. In particular, the flow diagram 400 shows how the master mobile device 112 can break-in the conversation at any time, even if the slave device 116 has control of the talk channel.

At 402, the Master device 112 can send a PTT request to the slave 116. In practice, the request alone with other messages, may be relayed through a FNE to provide call handling. At step 404, the slave can establish a call connection with the master device 112. Upon establishing the call, the master device can send audio to the slave device. For example, the user of master device can speak on the talk channel. The master device can also send a priority at step 408 which is of a priority level higher than the slave device 116. In one arrangement, the priority can be sent in an audio mute channel while the user of the master device is speaking. For example, the priority can be inserted in a silence frame between voice frames during the speaking. In another example, the priority can be sent via iExchange during a mute frame. In such regard, the priority is sent after the talk channel has been acquired since the priority can be sent within the silence packets. At step 410, the master device 112 can release the PTT and control of the talk channel. Since the talk channel is available, the slave device 116 can acquire the talk channel. In alternate arrangement, the priority can be sent over an SIP (Session Initiated Protocol) IP based network that is utilized in a PTT over Cellular System.

At step 412, the slave device can send a PTT request to the master device. At step 414, the master device can accept the PTT connect, and the call can be established. At step 41 8, the slave device 116 can send a priority indicating a precedence for break-in. Similarly, the slave device 116 can send the priority during an audio mute while the user of the master device is speaking. For example, the priority can be inserted within a silence frame during the speaking. Upon receiving, the priority from the slave device, the master can establish precedence over the slave if the priority of the slave is lower. In the current example, the slave device 116 has a lower priority than the master device 112. Accordingly, the master device 112 can break-in the conversation even if the slave device 116 has control of the talk channel. That is, the master device 112 can break-in during the talk-time of the slave device.

At step 420, the master device 112 can send a PTT request to the slave even though the slave has control of the talk channel. The slave device 116, based on the priority must terminate the call at step 422, and reconnect to the master at step 424. That is, even though the user of the slave device is speaking and holding down the PTT button, the user of the master device can break-in to the conversation. At step 426, the user of the master device 112 can acquire control of the talk channel and begin speaking. In such regard, the user of the slave device is interrupted based on the priority of break-in. Moreover, the slave device 116 cannot interrupt the master device on the talk channel since the master device 112 has greater priority over the slave device 116.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention is not so limited. Numerous modifications, changes, variations, substitutions and equivalents will occur to those skilled in the art without departing from the spirit and scope of the present embodiments of the invention as defined by the appended claims.

What is claimed is:

1. A method for push-to-talk (PPT) break-in, the method comprising:
assessing user context levels for users of mobile devices;
prioritizing a break-in precedence for users based on the user context levels; and
granting a break-in request to users engaged in conversation in order of priority,
wherein the user context identifies a hierarchical relationship between the users.

2. The method of claim 1, wherein the prioritizing is based on a user's role during a conversation.

3. The method of claim 1, wherein the prioritizing is based on a calendar or time of day.

4. The method of claim 1, wherein the prioritizing is based on an employee directory listing, a family relationship, a temporary group relationship, safety management, or emergency situations.

5. The method of claim 1, wherein the prioritizing is based on social networking.

6. The method of claim 1, wherein a priority is assigned for a period of time.

7. The method of claim 1, further comprising
receiving a request from a first mobile device to break-in an active call of a target mobile device;
determining a first priority of the first mobile device during the active call in view of the user context levels; and
granting the break-in if the first priority is greater than or equal to a current priority of a mobile device engaged in the active call.

8. The method of claim 1, wherein the user context levels are stored in a priority list on a mobile device.

9. The method of claim 1, wherein the step of determining a first priority further comprises:
receiving priorities from mobile devices engaged in the active call; and
comparing the first priority to the priorities received.

10. The method of claim 1, further comprising providing an indication when the break-in is granted.

11. The method of claim 10, wherein the step of granting the break-in further comprises:
sending a first message to suspend the active call;
sending a second message to accept the call from the first mobile device; and
connecting the first mobile device and the target mobile device in a second active call.

12. A system for push-to-talk (PTT), the system comprising:
a fixed network equipment (FNE) that receives a request from a first mobile device to break-in an active call of a target mobile device and arbitrates the active call of the target mobile device and the break-in of the first mobile device in accordance with priorities identified by user context levels,
wherein the target mobile device receives the request from the first mobile device, compares a first priority of the first mobile device to a list of priorities that identify a break-in priority for mobile devices in the active call, and grants the break-in to the active call if the first priority is greater than a second priority of a second mobile device in the active call, wherein the user context identifies a hierarchical relationship between the users.

13. The system of claim 12, wherein the system identifies which mobile device is in control of a talk channel during the active call, and evaluates a break-in priority based on the mobile device that has control of the talk channel.

14. The system of claim 13, wherein the system grants the break-in during a talk time of the target mobile device if the first priority is greater than a priority of the target mobile device.

15. The system of claim 13, wherein the system grants the break-in during a talk time of the second mobile device if the first priority is greater than the second priority.

16. A push-over-cellular (PoC) system providing push-to-talk (PTT) break-in, the system comprising:
a target mobile device engaged in an active call;
a first mobile device that sends a request to break-in the active call of the target mobile device; and
a fixed network equipment (FNE) that receives the request and arbitrates the active call of the target mobile device and the break-in of the first mobile device based on a user context that identifies a hierarchical relationship among users,
wherein the target mobile device receives the request from the first mobile device, compares a first priority of the first mobile device to a list of priorities that identify a break-in priority for mobile devices in the active call based on user context levels, and grants the break-in to the active call if the first priority is greater than a second priority of a second mobile device in the active call.

17. The system of claim 16, wherein the user context establishes a precedence of break-in based on a user role, user calendar, or time of day.

18. The method of claim 16, wherein the user context identifies a precedence of break-in based on an employee directory listing, a family relationship, safety management, or emergency situations.

19. The method of claim 16, wherein the user context identifies a precedence of break-in based on social networking, wherein a first user is socially more closer than a second user is given a higher priority than the second user.
